(19) United States
(12) Patent Application Publication
(10) Pub. No.: US 2025/0104388 A1
(43) Pub. Date: Mar. 27, 2025

(54) SYSTEM AND METHODS FOR INCREASING IMAGE QUALITY USING A MORPHOLOGICAL-BASED COMPOSITION

(71) Applicant: Araceli Biosciences Inc., Tigard, OR (US)

(72) Inventor: Shiou-jyh Ja, Portland, OR (US)

(21) Appl. No.: 18/472,082

(22) Filed: Sep. 21, 2023

(51) Int. Cl. G06V 10/60; G06T 3/40; G06T 7/62

(52) U.S. Cl. CPC G06V 10/60; G06T 3/40; G06T 7/62; G06T 2207/10056; G06T 2207/20036

(57) ABSTRACT

Methods and systems are provided herein for generating a morphology-based composition based on an input image, the morphology-based composition being a final image generated by performing one or more white top hat (WTH) transforms on the input image, generating two or more image layers based on two or more WTH transformed images, and scaling adjacent image layers based on one or more scaling factors, each scaling factor being based on an estimated point spread function (PSF), two structure element sizes, and standard deviations of the estimated point spread function (PSF) and image data.

### FIELD

Embodiments of the subject matter disclosed herein relate generally to image quality and morphology-based compositions.

### BACKGROUND/SUMMARY

Various imaging technologies, such as microscopy techniques, may be used to acquire digital images of cells, biological structures, or other materials. Due to the diffractive nature of light fields and aberration of an optical imaging system, resolution of an acquired image and image quality may be reduced. More specifically, high frequency details including edges and corners in a dark-field digital image acquired with a fluorescence microscope may be rounded and small feature attenuated due to a limited spatial frequency response imposed by the imaging system. Additionally, the image may include excessive background intensity variation, which may be due to the system noise, stray light, non-uniform illumination, or emissions from defocused objects in the sample volume.

One approach for restoring resolution of the acquired image is by implementing a two-dimensional (2D) deconvolution based on a known point spread function (PSF). In particular, the Richardson-Lucy deconvolution algorithm may be implemented to restore resolution of the acquired image. While the Richardson-Lucy deconvolution algorithm and similar methods have been used to restore image resolution, the degree wherein image resolution may be restored using deconvolution approaches may be limited. For example, restoration of image resolution using 2D deconvolution may be reduced due to a presence of noise and background intensity variation in the acquired image. Two-dimensional (2D) deconvolution is unable to remove a highly defocused image in the background and may cause undesired noise amplification and artifacts in a final image.

Further, the Richardson-Lucy deconvolution algorithm relies on a user-provided PSF. The use of an incorrect PSF may result in the presence of undesired distortion in the final image. As such, the deconvolution algorithm relies on a correct PSF. However, the process for determining the PSF accurately may be time intensive. Additionally, the iterative nature of the Richardson-Lucy deconvolution algorithm introduces uncertainty regarding the computation time since termination criteria may be difficult to determine. An early termination may not achieve a desired increase in resolution of the acquired image whereas a later termination may cause undesired artifacts, such as noise amplification, a dark halo, or an intensity ringing effect wherein periodic intensity undulation-like ripples appear around edges of a bright object. The disadvantages may be alleviated by user intervention. User intervention may include addressing undesired artifacts in a trial-and-error manner, which may increase the time duration of image processing and renders automation of image processing unlikely.

The inventors herein have recognized the above-mentioned issues and have engineered a way to at least partially address them. In one example, a method may include generating a morphology-based composition based on an input image, the morphology-based composition being a final image generated by performing two or more white top hat (WTH) transforms on the input image, generating two or more image layers based on two or more WTH transformed images, and scaling adjacent image layers based on one or more scaling factors, each scaling factor being based on an estimated point spread function (PSF), two structure element sizes, and the image data. In this way, relevant structures in the image may be extracted based on size, shape, and intensity level with an estimated PSF, which may enable layers of the input to be extracted. By applying specific weights or scaling factors to the layers, image restoration comparable to or surpassing 2D deconvolution algorithms may be achieved. The accuracy of the estimated PSF is to be increased after applying the proposed method.

Advantages that may be realized in practicing the above-described method include decreased background interference and/or other undesired image artifacts due to additional image processing and increased resolution of an acquired image without significant burden on the user. In particular, by knowing a rough size of the PSF and structures within the image that may be refined, the out-of-focus image and other background intensity issues due to vignetting or non-uniform illumination may be minimized and/or removed. Since the method may be performed with minimal knowledge of the user, burden on the user may be minimized when compared to 2D deconvolution algorithms. In addition, the method is compatible with GPU processing and may be performed in parallel, which may result in acceptable image processing times (e.g., a fraction of a second).

The above advantages and other advantages, and features of the present description will be readily apparent from the following detailed description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a diagram of a computing device.

FIG. 2 shows a block diagram of a process for increasing 2-dimensional (2D) image resolution using a morphological-based composition.

FIG. 3 shows a flow chart of an example method for generating a morphological-based composition to increase 2-dimensional (2D) image resolution.

FIGS. 4A-4F show examples of a phantom image, examples of final images, and examples of white top hat (WTH) transformations of the phantom image.

FIGS. 5A-5D show a first example of implementing a morphological based composition using a phantom image.

FIGS. 6A-6D show a second example of implementing a morphological-based composition using a phantom image.

### DETAILED DESCRIPTION

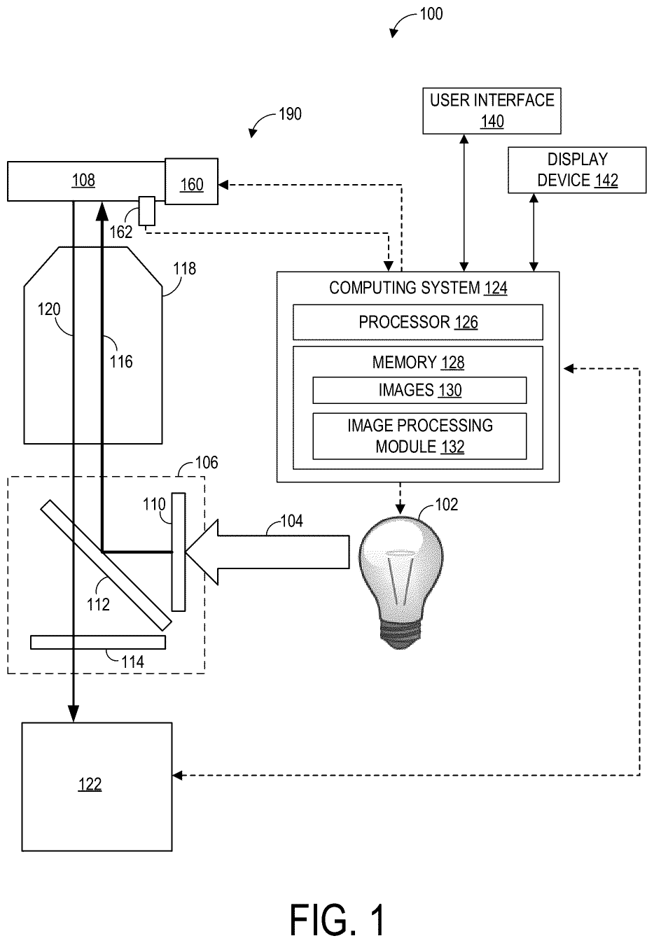

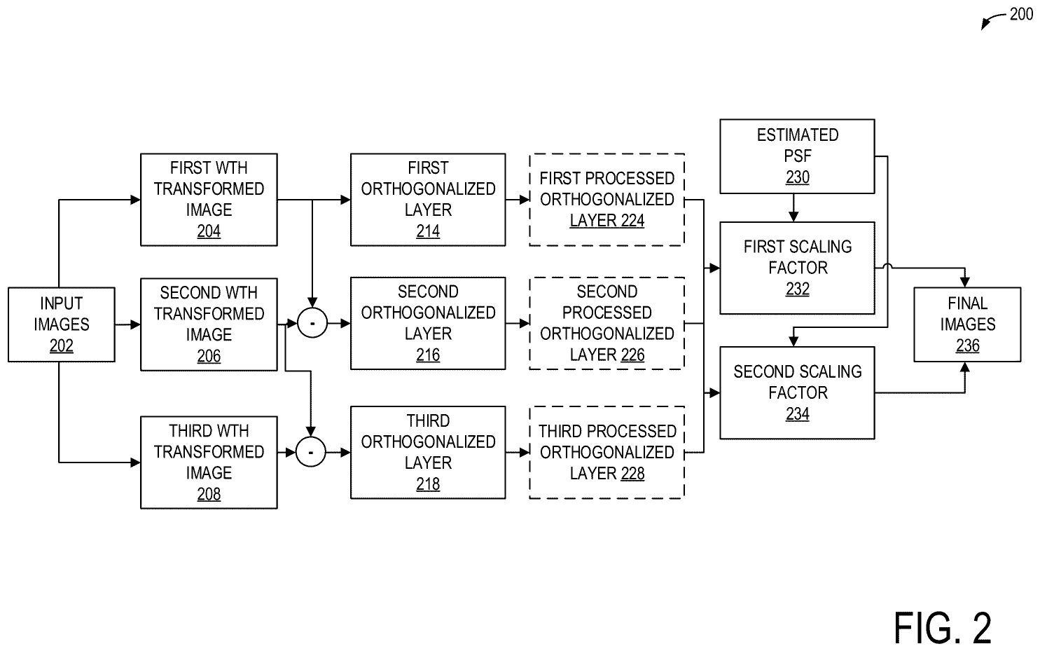

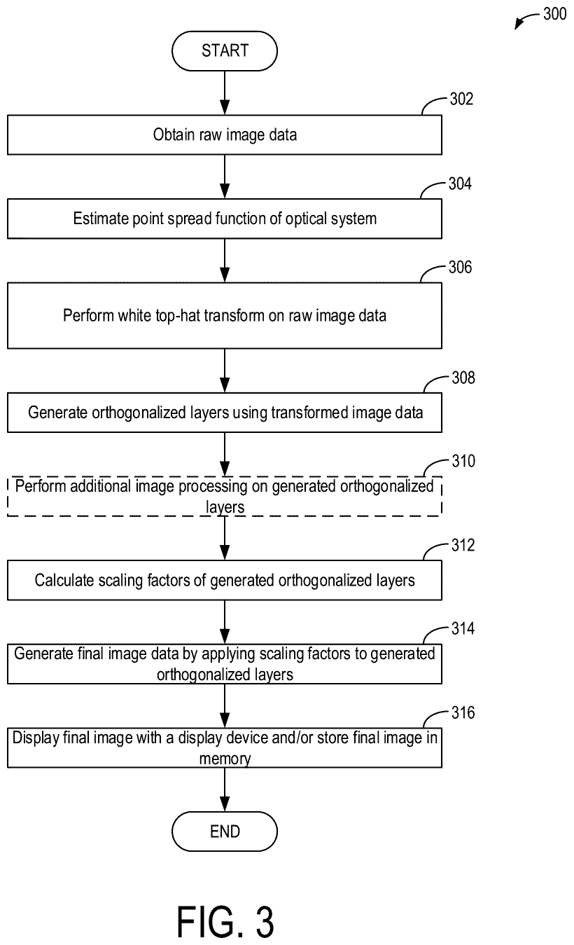

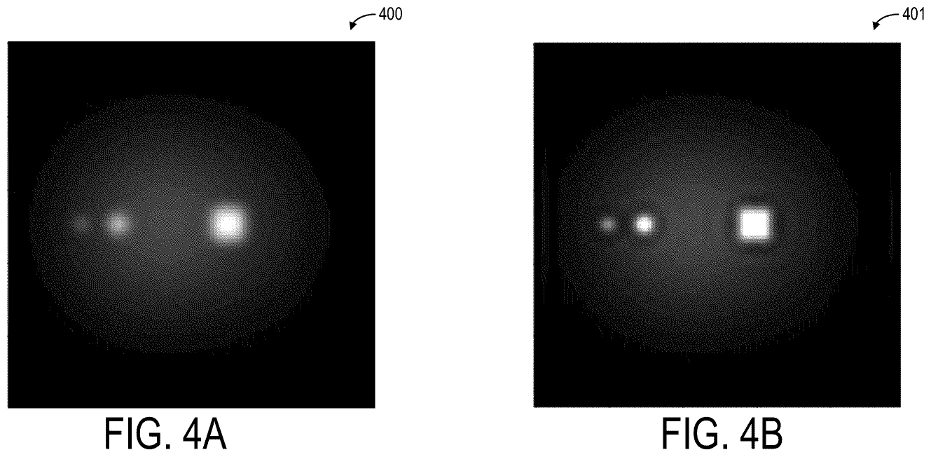

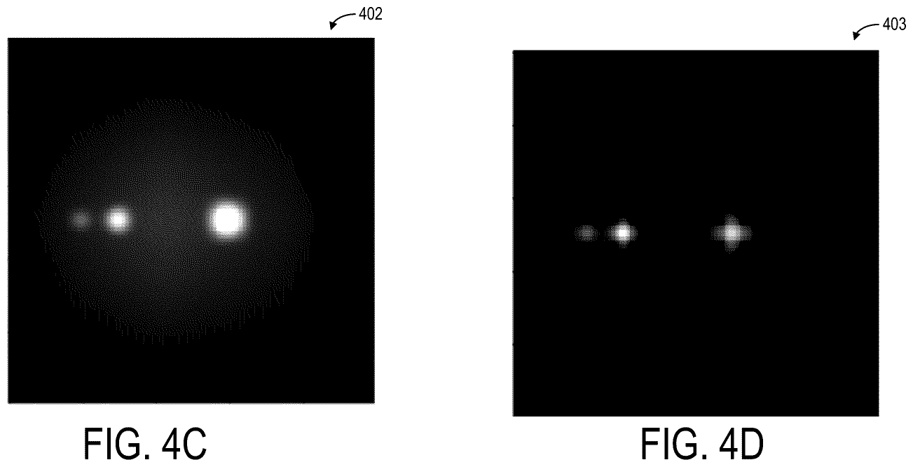

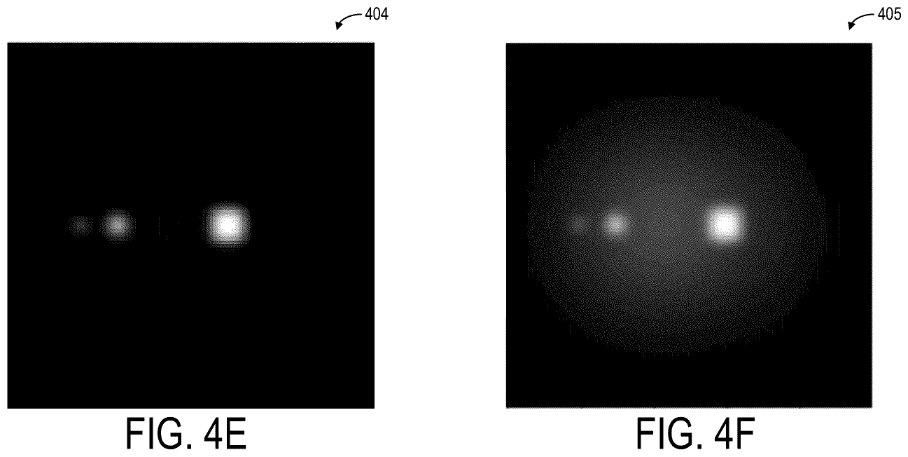

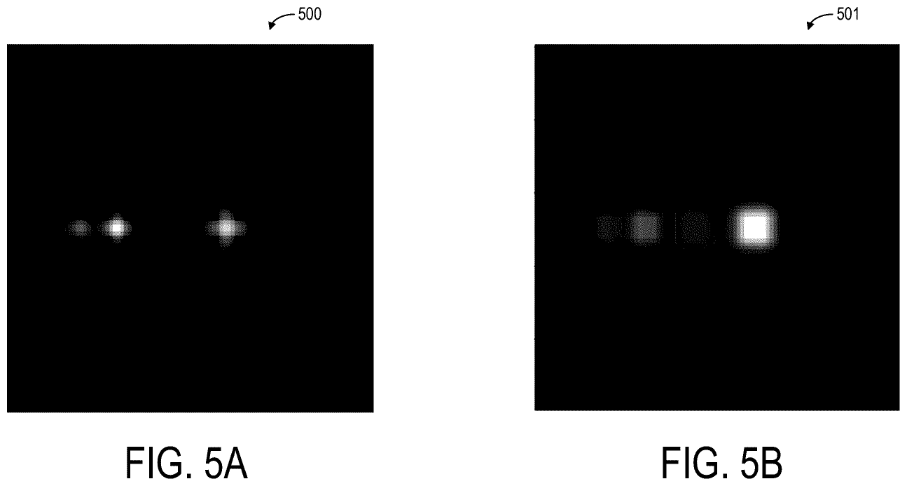

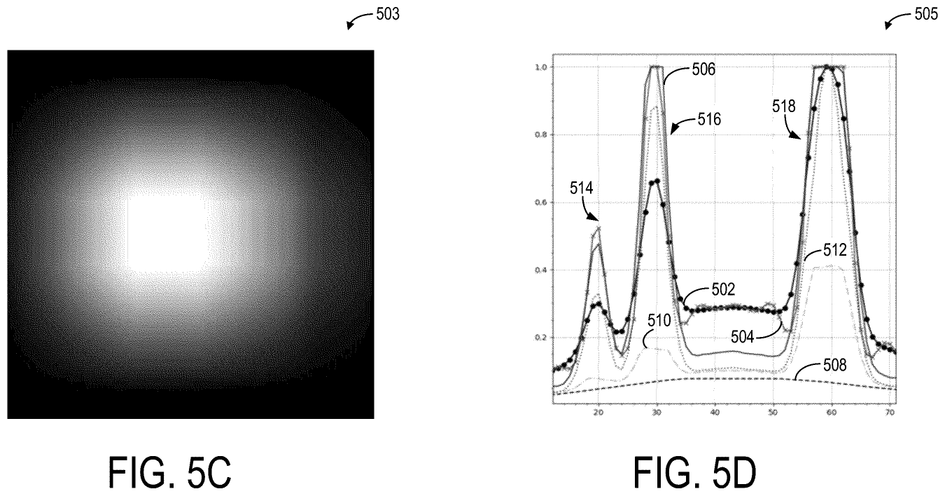

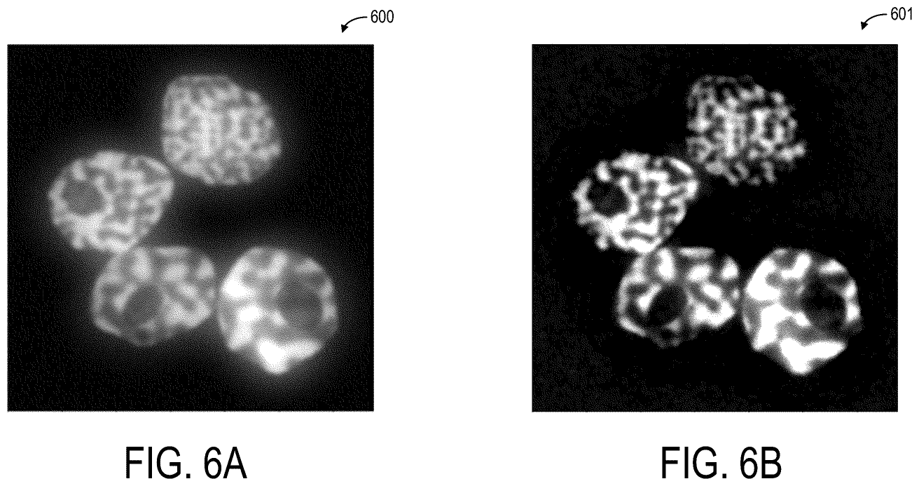

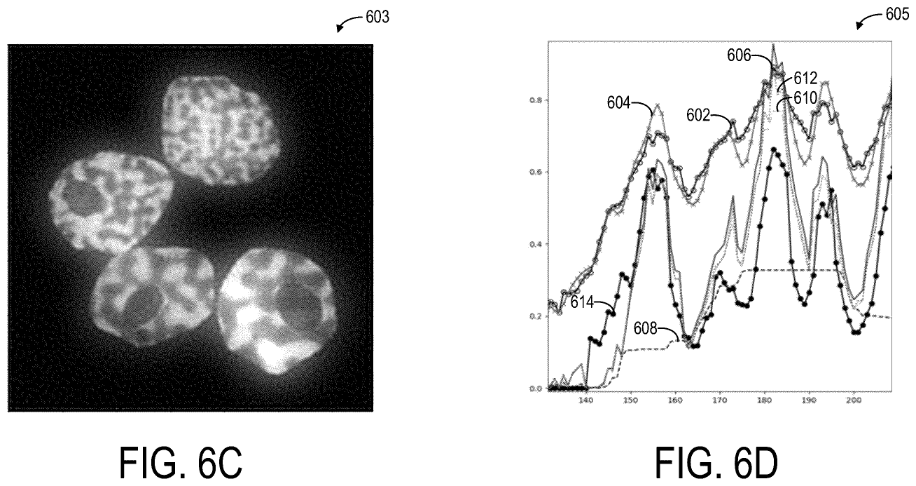

The present description is related to systems and methods for increasing image quality by generating morphological-based compositions based on an input image. Methods for increasing image quality with morphological-based compositions may be performed using a computing system, such as the computing system shown in FIG. 1. A process for generating a morphological-based composition to increase 2-dimensional (2D) image resolution is shown in FIG. 2. FIG. 3 illustrates a method for generating the morphology-based composition based on the input image. FIGS. 4A-4F show examples of a phantom image, example of final images generated with two-dimensional (2D) deconvolution and according to the embodiments described herein, a plurality of white top hot transforms performed on the phantom image according to the method described herein. FIGS. 5A-5D show a first example of generating a morphology-based composition based on a phantom image. FIGS. 6A-6D show a second example of generating a morphology-based composition based on a phantom image.

Turning now to FIG. 1, a schematic diagram for a system 100 is shown. In one example, the system 100 may be configured as a wide-field microscopy system, such as a fluorescence microscopy system as herein described, though other configurations of the system 100 are possible. An imager 190 of the system 100 may include a light source 102 providing incident light to components arranged in a path of the incident light, as indicated by arrow 104. The light source 102 may be a mercury-vapor lamp, a xenon arc lamp, a laser, or one or more light-emitting diodes (LEDs). In some examples, the system 100 may be included in a multi-detector microscope system.

The incident light may be directed to a filter cube 106 (e.g., also called a filter block). The filter cube 106 may house components that filter the incident light such that target wavelengths are transmitted to a target to be analyzed, e.g., one or more samples supported on a sample holder 108. In one example, the sample holder 108 may be a microplate. In the example of FIG. 1, three filtering components are arranged in the filter cube 106, including an excitation filter 110, a dichroic filter 112, and an emission filter 114. The incident light may first pass through the excitation filter 110 which filters the light to allow select, e.g., target, wavelengths to continue past the excitation filter 110 and block other wavelengths of light. The target wavelengths may be wavelengths that excite electrons in specific fluorophores or fluorochromes, resulting in release of photons when the excited electrons relax to a ground state.

The excitation light, e.g., light that has been filtered by the excitation filter 110, then strikes the dichroic filter 112 (or dichroic beamsplitter), as indicated by arrow 116. The dichroic filter 112 may be a mirror, for example, arranged at a 45 degree angle relative to an optical path of the system 100, e.g., angled at 45 degrees relative to the path of incident light indicated by arrow 104. A surface of the dichroic filter 112 may include a coating that reflects the excitation light, e.g., light filtered by the excitation filter 110, but allows fluorescence emitted from the sample at the sample holder 108 to pass therethrough. The reflected excitation light, as indicated by arrow 116, passes through an objective lens 118 to illuminate the sample holder 108. If the sample positioned in the sample holder 108 fluoresces, light is emitted, e.g., generating emission light as indicated by arrow 120, and collected by the objective lens 118. The emission light passes through the dichroic filter 112 and continues to the emission filter 114, which blocks undesired excitation wavelengths from passing therethrough. The filtered emission light is received at a detector 122. The detector 122 may be a camera, such as a charge-coupled device (CCD) camera, in one example. In other examples, the detector 122 may be another type of camera, for example, a CMOS camera, or a photomultiplier tube.

At the detector 122, the emission light may be converted into electronic data. For example, when the detector 122 is the CMOS camera, the detector 122 may include a light sensor configured as a transistor on an integrated circuit. Photons of the emission light may be incident on the light sensor and generate an electrical charge that is converted into electronic data representative of a photon pattern of the emission light captured within a field of view (FOV) of the camera. The electronic data may be stored at a memory of the camera, such as random access memory, and may be retrieved by a computing system 124.

The computing system 124 may be a computing device or other computer. The computing system 124 may include a processor 126 and a memory 128. The processor 126 may comprise one or more computational components usable for executing machine-readable instructions. For example, the processor 126 may comprise a central processing unit (CPU) or may include, for example a graphics processing unit (GPU). The processor 126 may be positioned within the computing system 124 or may be communicatively coupled to the computing system 124 via a suitable remote connection.

The memory 128 may comprise one or more types of computer-readable media, including volatile and/or non-volatile memory. The volatile memory may comprise, for example, random-access memory (RAM), and the non-volatile memory may comprise read-only memory (ROM). The memory 128 may include one or more hard disk drive(s) (HDDs), solid state drives (SSDs), flash memory, and the like. The memory 128 is usable to store machine-readable instructions, which may be executed by the processor 126. The memory 128 is further configured to store images 130, which may comprise digital images captured or created using a variety of techniques, including digital imaging, digital illustration, and more. The images 130 may further include one or more reference images and/or one or more acquired images.

At least a portion of the images 130 may be acquired via the system 100. The memory 128 further includes an image processing module 132, which comprises machine-readable instructions that may be executed by the processor 126 to increase resolution of the images 130 by performing morphology-based methods to generate a morphological-based composition. The image processing module 132 thus contains machine-readable instructions for manipulation of digital images (e.g., the images 130), such as instructions to perform white top hat transforms on the images and generate two or more image layers that may be scaled to increase image quality and image resolution. For example, the machine-readable instructions stored in the image processing module 132 may correspond to one or more methods, examples of which are provided with respect to FIG. 3.

The system 100 further include a user interface 140, which may comprise one or more peripherals and/or input devices, including, but not limited to, a keyboard, a mouse, a touchpad, or virtually any other input device technology that is communicatively coupled to the computing system 124. The user interface 140 may enable a user interact with the computing system 124, such as to select one or more images to evaluate, to select one or more parameters of the imager 190, and so forth.

The system 100 further includes a display device 142, which may be configured to display results of resolution correction, display the images themselves, and display possible parameter options and selections related to the acquisition of images, including one or more dye wavelengths, channels, and emission spectra, for example. The user may select or otherwise input parameters via the user interface 140 based on options displayed via the display device 142.

The computing system 124 may be communicatively coupled to components of the system 100. For example, the computing system 124 may be configured to command activation/deactivation of the light source 102 when prompted based on user input. As another example, the computing system 124 may instruct adjustment of a position of the sample holder 108 to focus the excitation light on a different region of the sample holder. The computing system 124 may command actuation of a motor 160 coupled to the sample holder 108 to vary the position of the sample holder 108 with respect to the objective lens 118 and the excitation light and provide instructions on how the sample holder position is to be modified. In some examples, a position sensor 162 may monitor the actual position of the sample holder 108 and may be communicatively coupled to the computing system 124 to relay the sample holder position to the computing system 124.

The computing system 124 may also be communicatively coupled to the detector 122. As such, electronic data collected by the detector 122 may be retrieved by the computing system 124 for further processing and display at an interface, such as a computer monitor. It will be appreciated that the computing system 124 may be further coupled to other sensors and actuators of the system 100. In one example, communication between the computing system 124 and the sensors and actuators of the system 100 may be enabled by various electronic cables, e.g., hardwiring. In other examples, the computing system 124 may communicate with the sensors and actuators via a wireless protocol, such as Wi-Fi, Bluetooth, Long Term Evolution (LTE), etc.

It will be appreciated that the system 100 depicted in FIG. 1 is a non-limiting example of a system with an imager and a computing device. Other examples may include variations in quantities of individual components, such as a number of dichroic, excitation, and emission filters, a configuration of the light source, relative positioning of the components, etc. In one example, the system 100 may be used for high through-put screening of biological samples. It should also be understood that the methods and systems herein described are not limited to microscopy systems and may be implemented for other types of imaging systems such as computerized tomography (CT), positron emission tomography (PET), magnetic resonance angiography (MRA), and more.

As illustrated in FIG. 2, a process 200 for implementing a morphological-based composition to increase image resolution and image quality. The process 200 includes generating a morphological-based composition using input images 202 that are transformed, orthogonalized, processed, and scaled, accordingly. The input images 202 may include a plurality of images acquired with florescence microscopy, for example. However, the plurality of images may be acquired with other imaging systems.

Two or more white top hat (WTH) transforms may be performed on an input image in the input images 202, including a first white top hat (WTH) transform, a second white top hat (WTH) transform, and a third white top hat (WTH) transform to generate two or more WTH transformed images, such as a first WTH transformed image 204, a second WTH transformed image 206, and a third WTH transformed image 208, respectively. The two or more WTH transformed images are generated by performing the two or more WTH transforms based on two or more structure elements wherein each structure element is a different size, shape, and element. The element may be either be either a binary element (e.g. a Boolean value of true or false or integer of 1 or 0) or a float point element. Among all the variations of the structure element, the size of the structure element may have the most significant effect on the result.

More specifically, the first WTH transform may be performed using a first structure element to generate the first WTH transformed image 204, the second WTH transform may be performed using a second structure element to generate the second WTH transformed image 206, and the third WTH transform may be performed using a third structure element to generate the third WTH transformed image 208. Each structure element is a different size and has a pre-determined geometry and pre-determined value.

A first structure element size, a third structure element size, and a third structure element size are all different values. In this way, image features of various sizes and intensities may be extracted into different layers. In other words, the first structure element size may extract image features of a certain size in the input image, the second structure element size may extract image features of a certain size in the same input image that are different than the size of image features extracted using the first structure element size, and the third structure element size may extract image features of a certain size in the same input image that are different than the size of the image features extracted using the first structure element size and second structure element size. FIGS. 4D-4F illustrates transformed images wherein various image components are extracted from a phantom image.

Two or image layers may be generated based on the two or more WTH transformations. The two or more image layers may be mutually excluded to form the orthogonalized layers where each orthogonalized layer is linearly independent from the remaining orthogonalized layers. Each orthogonalized layer comprises one of a WTH transformed image generated with a smallest structure element or an image generated by subtracting one WTH transformed image with a smaller structure element from another WTH transformed image with a larger structure element. The two WTH transformed images that are subtracted from one another are generated with two different, smaller structure elements.

The two or more orthogonalized layers comprises one of at a top layer and a base layer or the top layer, one or more intermediate layers, and the base layer. The top layer is computed with a smallest structure element and the base layer is computed with a largest structure element. As one example, the two or more orthogonalized layers may include at least the top layer and base layer when two WTH transforms are performed on the input image. As another example wherein three WTH transforms are performed on the input image, the first WTH transformed image 204, the second WTH transformed image 206, and the third WTH transformed image 208 may be orthogonalized to generate two or more orthogonalized layers that are linearly independent, such as a first orthogonalized layer 214, a second orthogonalized layer 216, and a third orthogonalized layer 218. The first orthogonalized layer 214 may be the first WTH transformed image 204. The first orthogonalized layer 214 may be the top layer. The second orthogonalized layer 216 may be generated by subtracting the first WTH transformed image 204 from the second WTH transformed image 206. The second orthogonalized layer 216 may be the intermediate layer. The third orthogonalized layer may be generated by subtracting the second WTH transformed image 206 from the third WTH transformed image 208. The third orthogonalized layer 218 may be the bottom layer.

The process 200 may optionally include additional image processing of the first orthogonalized layer 214, the second orthogonalized layer 216, and the third orthogonalized layer 218 to generate a first processed orthogonalized layer 224, a second processed orthogonalized layer 226, and a third processed orthogonalized layer 228. The additional image processing may include denoising, intensity-based filtering, and/or other types of filtering.

The two or more processed orthogonalized image layers may be scaled to compose a final image in final images 236. The two or more processed orthogonalized layers may be scaled by calculating one or more scaling factors between pairs of adjacent orthogonalized layers, which includes an upper orthogonalized layer and a lower orthogonalized layer, and applying each of the scaling factors to the upper orthogonalized layers of the pairs to generate the final image. A scaling factor is a ratio between a respective orthogonalized layer wherein the scaling factor is applied (e.g., the upper orthogonalized layer of the pair) and a lower layer. Since each layer has been orthogonalized, there is no compound effect among the applied scaling factors. The pairs of adjacent orthogonalized layers may include one of the top layer and the base layer, the top layer and one of the one or more intermediate layers, two intermediate layers of the one or more intermediate layers, and one of the one or more intermediate layers and the base layer. A final image in final images 236 may be generated by applying each scaling factor to a respective orthogonalized layer of the pair of adjacent orthogonalized layers and composing the final image based on one or more scaled orthogonalized layers.

In an example, three orthogonalized layers, such as the first orthogonalized layer 214, the second orthogonalized layer 216, and the third orthogonalized layer 218, which may be denoted as L₁, L₂, and L₃, may be extracted according to the embodiments described herein. Two scaling factors, which may be donated as S₁ and S₂, respectively, are calculated for pairs of adjacent orthogonalized layers. In one embodiment, the first orthogonalized layer 214 and the second orthogonalized layer 216 may be a first pair of adjacent orthogonalized layers denoted as L₁/L₂ and the second orthogonalized layer 216 may be a second pair of adjacent orthogonalized layers denoted as L₂/L₃. The scaling factor S₁ may be applied to L₁, since L₁ is the upper orthogonalized layer of the first pair of adjacent orthogonalized layers and the scaling factor S₂ may be applied to L₂ since L₂ is the upper orthogonalized layer of the second pair of adjacent orthogonalized layers. After application of the scaling factors S₁ and S₂, the three orthogonalized layers are summed to generate a final image of final images 236.

As one example, a first scaling factor 232 between the first orthogonalized layer 214 (or first processed orthogonalized layer 224) and the second orthogonalized layer 216 (or second processed orthogonalized layer 226) may be calculated based on an estimated Point Spread Function (PSF 230) of the imaging system to be reached. A second scaling factor 234 between the second orthogonalized layer 216 (or second processed orthogonalized layer 226) and the third orthogonalized layer 218 (or third processed orthogonalized layer 228) may be calculated based on the estimated PSF 230 to be reached. By applying the first scaling factor 232 and the second scaling factor 234, the final image in final images 236 may be generated wherein the final image is a higher quality image than the input image. The final image may be considered a morphological-based composition. Calculation and application of the scaling factors is described below with respect to FIG. 3.

The process 200 described above is exemplary and does not limit the scope of the present disclosure. In other embodiments, the process 200 may include performing additional or less WTH transforms on the input image without departing from the scope of the present disclosure. Further, the process 200 may include applying additional or less scaling factors based on the number of WTH transforms of the input image.

FIG. 3 shows a method 300 for increasing resolution of an image acquired with an imaging system, such as the system 100 of FIG. 1. The method 300 may be executed by a processor of a computing system, such as the processor 126 of the computing system 124 of FIG. 1, according to instructions stored in a non-transitory memory of the computing system (e.g., within the image processing module 132 of the memory 128 of FIG. 1).

At 302, the method 300 includes obtaining input image data. Input images may be acquired via the imaging system during data acquisition, such as the system described above with respect to FIG. 1. The input image may be obtained during the time wherein the system is actively performing high-speed image data acquisition (DAQ). In some embodiments, the input image may comprise a biological sample.

At 304, the method 300 includes estimating a point spread function (PSF) of an optical system. The points spread function (PSF) may be estimated by an analytical equation based on a numerical aperture of an objective and a wavelength of the imaging system. The analytical equation may be based on known criterions, such as the Rayleigh criterion and the like. In this way, the PSF may be estimated instead of measured.

At 306, the method 300 includes performing a white top-hat transform on the input image data. The white top hat (WTH) transform may be performed according to the following equation:

$$W T {H}_{i} ( I ) = I - ( I ∘ {SE}_{i} ) \qquad ( 1 )$$

where I is an input image, SE is a structure element with a size of i, ∘ is an opening operation, and WTHᵢ, is an extracted image component. The two or more WTH transforms may be performed simultaneously due to the configuration of the hardware, which may reduce a time duration for image processing when compared to 2D deconvolution.

In some embodiments, the input image I may be the input image data and the opening operation may be an erosion followed by a dilation of the input image. The extracted image component WTHᵢ may be extracted using a structure element SEᵢ with the size of i. The structure element SEᵢ may be differently sized and have different geometries. The structure element SEi may be sized based on a number of pixels within the structure element SEᵢ. For example, a structure element SE₃ wherein i=3 includes a 3×3 pixel array and a structure element SE₂₁ wherein i=21 includes 21×21 pixel array. It may be noted that the number, i, may strictly be an odd number for an unambiguous definition of a center of the structure element.

With regards to having different geometries, in one embodiment, the structure element SEᵢ may be a flat or non-flat structure element. In another embodiment, the structure element SEᵢ may be a circular structure element or square structure element. In some embodiments, the square structure element may reduce computation time due to having the same dimensions in an x-direction and y-direction. More specifically, a 2D WTH transform may be separately decomposed, meaning a 2D WTH transform result may be achieved by performing one-dimensional (1D) WTH transforms in the x-direction and y-direction. By separately decomposing the 2D WTH transform, a 2D WTH transformation result may be achieved with reduced computational expense and computation time.

However, the circular structure element may be more compatible with common biological samples, such as cells. Since the circular structure element may be approximated by a staircase circumference, which may then be decomposed into smaller structure elements, computation may be optimized based on the specific computation hardware. Regardless of the size and geometry of the structure element, the WTH transformations of the input image are compatible with GPU processing and may be performed in parallel, which may result in acceptable image processing times (e.g., a fraction of a second). Due to the shorter processing times, after selection of the sizes of the structure elements, image processing according to the method 300 may be automated and may not rely on intervention from a user to generate final images with increased image quality and resolution.

It may be understood that the examples provided for the various aspects of the structure element SEᵢ are not meant to limit the scope of the present disclosure. The sizes and geometries of the structure element SEᵢ may deviate from the examples provided without departing from the scope of the present disclosure. By performing the white top-hat transform on the input image, an image may be generated that includes extracted image components WTHᵢ.

As one example of performing the white top-hat transform on the input image data, a plurality of white top-hat transforms may be performed on the same input image data as shown above with regards to FIG. 2 to generate a plurality of WTH transformed images with extracted image components. The plurality of white top-hat WTH transforms may include a first WTH transform, a second WTH transform, and a third WTH transform that may be performed on the first input image to generate a first WTH transformed image with extracted image components, a second WTH transformed image with extracted image components, and a third WTH transformed image with extracted image components, respectively.

The first white top-hat transform may be performed with a first structure element of a first size, the second white top-hat transform may be performed with a second structure element of a second size, and a third white top-hat transform may be performed with a third structure element of a third size. The first size of the first structure element is smaller than the second size of the second structure element. The second size of the second structure element is smaller than the third size of the third structure element. The first size of the first structure element is smaller than the third size of the third structure element. In other words, the first structure element is the smallest, the third structure element is the largest, and the second structure element is an intermediate size between the first structure element and the third structure element.

According to the Nyquist theorem, the smallest features (or highest frequency component) in the image may be represented by twice the size of the pixel. In other words, the WTH transform extracts image features smaller than the size of the structure element, similar in shape to the structure element, and brighter than the surrounding. Since biological samples may be the subject of the input image, a suitable candidate to extract high frequency features of the input image into the first WTH transform may be a circular first structure element with a first size of 3 pixels (e.g., 3×3 pixels).

However, the first structure feature with the first size of 3 pixels may not be suitable when magnification of the optical system is large enough that the PSF becomes larger and/or a signal-to-noise ratio of the image is poor and a larger structure element may be selected to avoid noise amplification. With regards to the third WTH transform, the third size of the third structure element may be selected based on the largest size of the desired image feature of a biological sample to be included in the final image (e.g., the morphological-based composition). Features larger than the largest structure element may be severely attenuated in the final image. The second size of the second structure element may be selected based on secondary features that a user identifies as relevant.

In other embodiments, the plurality of white top-hat transforms may include fewer or additional white top-hat transforms on the same input image. In particular, at least two white top-hat transforms may be performed on the same input image. In embodiments wherein additional white top-hat transforms are performed, an increase in resolution may occur at the expense of additional computational costs and introducing complexity.

At 308, the method 300 includes generating orthogonalized layers using the transformed image data. The transformed image data may include two or more WTH transformed images with extracted image components acquired with the plurality of white top-hat transforms. Two or more orthogonalized layers may be generated based on the two or more WTH transformed images with extracted image components. In particular, the two or more WTH transformed images with extracted image components may be subtracted from one another in a specific manner to generate the two or more orthogonalized layers. The two or more orthogonalized layers are linearly independent and not related to each other. Generation of two or more orthogonalized layers is illustrated in FIGS. 5A-5C.

Returning to the example described above wherein two or more white top-hat transforms are performed on the same input image, the two or more WTH transformed images with extracted image components, which includes the first WTH transformed image with extracted image components, the second WTH transformed mage with extracted image components, and the third WTH transformed image with extracted image components, may be used to generate the two or more orthogonalized layers. As described herein, the first WTH transformed image with extracted image components is generated using the smallest structure element size, the second WTH transformed image with extracted image components is generated using the intermediate structure element size, and the third WTH transformed image with extracted image components is generated using the largest structure element size.

A first orthogonalized layer may be the first WTH transformed image with extracted image components, which may be a top layer. A second orthogonalized layer may be the difference between the second WTH transformed image with extracted image components and the first WTH transformed image with extracted image components, which may be an intermediate layer. A third orthogonalized layer may be the difference between the third WTH transformed image with extracted image components and the second WTH transformed image with extracted image components, which may be a base layer.

At 310, the method 300 includes performing additional image processing on the generated orthogonalized layers. The additional image processing may be applied to the two or more orthogonalized layers independently. In other words, each orthogonalized layer may be processed independently due to various image artifacts present in each orthogonalized layer. For example, the first orthogonalized layer may include noise that affects image resolution and image quality. A denoising algorithm may be applied to the first orthogonalized layer. In particular, the denoising algorithm may adjust the contribution of the first orthogonalized layer (e.g., top layer) relative to a combination of the second orthogonalized layer and third orthogonalized layer (e.g., the middle or intermediate layer and the base layer).

As one example, the first orthogonalized layer may be denoised according to equation 2:

$$L {1}_{w} = \frac{L 1}{( L 1 + L 2 ) / max ( L 1 + L 2 )} \qquad ( 2 )$$

where L1 is the first orthogonalized layer (or top layer), L2 is the second orthogonalized layer (or middle layer), L3 is the third orthogonalized layer (or base layer), L1_{w} is a weighted first orthogonalized layer (or weighted top layer), and the max operator takes the maximum intensity of the operand. By applying the intensity-based denoising algorithm of equation 2, noise in the background or low intensity areas of the input image may be attenuated.

In some embodiments, a low pass filtering algorithm, wavelet denoising algorithm, or processing mask-based algorithms may be applied to the orthogonalized layer to refine the layer and reduce the presence of noise. In other embodiments, the second orthogonalized layer and the third orthogonalized layer may include undesired intensity variation, which may be addressed by applying an intensity filtering algorithm. In this way, undesired artifacts that may appear in the final image due to the presence of noise or undesired intensity variation may be corrected before generation of the final image. Overall, by performing additional image processing on the two or more orthogonalized layer and addressing the specific factors in each layer that may reduce image quality in the input image, a final image without undesired image artifacts and increased image resolution and image quality may be generated.

At 312, the method 300 includes calculating scaling factors of the generated orthogonalized layers. Each scaling factor of the generated orthogonalized layers may be applied to the generated orthogonalized layers to weight each layer accordingly in order to increase spatial resolution of the final image (e.g., the morphology-based composition). The scaling factors may be determined based on the approximated PSF. For example, an intensity distribution of an object and PSF of the optical system may follow a Gaussian distribution with a specified standard deviation. The Gaussian function is shown in the equation below:

$$G ( d , s ) = exp ( \frac{- {d}^{2}}{2 \cdot {s}^{2}} ) \qquad ( 3 )$$

where s is a standard deviation and d is a size of a structure element. As such, d may be R₁ or R₂ and s may be σ₁ or σ₂ described below.

The scaling factor between two generated orthogonalized layers may be determined according to the following equation:

$$\frac{L 1}{L 2} = \frac{\frac{1 − G ( {R}_{1} , {σ}_{1} )}{1 − G ( {R}_{2} , {σ}_{1} )}}{\frac{1 − G ( {R}_{1} , {σ}_{2} )}{1 − G ( {R}_{2} , {σ}_{2} )}} \qquad ( 4 )$$

where G is a Gaussian function, σ₁ is a restored standard deviation, σ₂ is a blurred standard deviation, R₁ is a size of the structure element of a first layer (L₁), R₂ is a size of the structure element of a second layer (L₂). The restored standard deviation is the standard deviation of the targeted point spread function and the blurred standard deviation is a standard deviation of the acquired image data. Scaling the two or more pairs of orthogonalized layers according to equation 4 enables each orthogonalized layers to contribute appropriately to the final image based on an ability of each orthogonalized layer to increase image resolution, reduce the presence of undesired image artifacts, and increase overall image quality.

Equation 4 may be applied to the plurality of orthogonalized layers, including the first orthogonalized layer, the second orthogonalized layer, and the third orthogonalized layer, generated from the two or more WTH transformed images with extracted image components in the example described above. A first scaling factor between the first orthogonalized layer and the second orthogonalized layer may be calculated with equation 4. L₁ may refer to the first orthogonalized layer and L₂ may refer to the second orthogonalized layer.

It may be understood, that a ground truth image refers to an image without blurring and/or image artifacts that are introduced when an acquired image is captured by the imaging optical system. Blurring and image artifacts are present in the acquired image. Since the smallest size of the feature structure may be twice the image pixel size, an intensity distribution of a smallest object (e.g., ground truth) in a roughly critically sampled input image, it may be assumed that a ground truth PSF of the ground truth image is a Gaussian curve with a standard deviation of σ₁=1 pixel and a full width at half maximum (FWHM) of approximately 2.4 pixels. As described above, the acquired image may include blurring and image artifacts introduced by the imaging system. Accordingly, the PSF of the imaging optical system may also be approximated by a Gaussian function with a standard deviation of 2 pixels or other analytical function. When the PSF of the imaging optical system is approximated as described above a resulting imaged object (e.g., a blurred object) may have a PSF of a Gaussian distribution with a blurred standard deviation of σ₂=2.24 pixels.

Additionally, a second scaling factor between the second orthogonalized layer and the third orthogonalized layer may also be calculated with equation 4. In this case, L₁ may refer to the second orthogonalized layer and L₂ may refer to the third orthogonalized layer. Since the second orthogonalized layer and the third orthogonalized layer capture larger features of the input image, the size of the standard deviation of the Gaussian function of the intensity distribution for the second orthogonalized layer and the third orthogonalized layer may be more than 10 pixels, resulting in a reduced blurring effect of the PSF of the optical system, which has a PSF with a standard deviation, σ=2. As such, the restored standard deviation σ₁ and the blurred standard deviation σ₂ may be similar in value, causing the second scaling factor between the second orthogonalized layer and the third orthogonalized layer to be reduced to between 1 and 2.

As structure size in the input image increases, the advantages of resolution restoration are reduced since the blurring effect was reduced in the first place. In fact, when the scaling factor between two adjacent orthogonalized layers (e.g., the first and second orthogonalized layers or the second and third orthogonalized layers) is equal to 1, the two adjacent layers may be combined into a single layer in the morphology-based composition process since there is no benefit of using additional orthogonalized layers. The first scaling factor between the first orthogonalized layer (e.g., top layer) and the second orthogonalized layer (intermediate layer) is likely to be greater than unity, which is generally true for the top layer and middle layers.

As such, the first orthogonalized layer (or the top layer) and the second orthogonalized layer (or the intermediate layer) contribute significantly to the process of increasing in resolution. In contrast, the second orthogonalized layer (or the intermediate layer) and third orthogonalized layer (or the base layer) do not contribute significantly to the increase in resolution compared to the first orthogonalized layer and the second orthogonalized layers. Since the middle layer and base layer do not contribute significantly to the increase in resolution comparatively, including more than three layers or additional intermediate layers (or middle layers) in the morphology-based composition becomes less effective and even redundant.

In the example provided above, the estimated PSF of the optical system follows a Gaussian distribution. In some embodiments, the estimated PSF of the optical system may follow other types of distributions, including a Lorentzian distribution or a Moffat distribution. As such, equation 2 may be adjusted accordingly to incorporate the appropriate distribution to achieve a desired resolution restoration of the input image. In other embodiments, the estimated PSF may be widened due to the presence of excessive noise in the input image. To reduce the presence of noise, the scaling factor (e.g., the first scaling factor or the second scaling factor) may be reduced accordingly.

At 314, the method 300 includes composing final image data by applying the scaling factors to the generated orthogonalized layers. In particular, the final image may be generated by applying one or more scaling factors to one or more pairs of adjacent orthogonalized layers to generate the final image. As described herein, the pair of adjacent orthogonalized layers comprise one of the top layer and the base layer, the top layer and one of the one or more intermediate layers, two intermediate layers of the one or more intermediate layers, and one of the one or more intermediate layers and the base layer. Applying the scaling factors to compose the final image may include multiplying one orthogonalized layer of the pair of adjacent orthogonalized layers by a respective scaling factor for each pair of adjacent orthogonalized layers, and adding each scaled orthogonalized layer and non-scaled orthogonalized layer together. As mentioned herein, the scaling factor is applied to an upper orthogonalized layer of the pair of adjacent orthogonalized layers.

As an example, a first pair of adjacent orthogonalized layers may include the first orthogonalized layer and the second orthogonalized layer and a second pair of adjacent orthogonalized layers may include the second orthogonalized layer and the third orthogonalized layer. Since the first orthogonalized layer is an upper orthogonalized layer of the first pair and the second orthogonalized layer is an upper orthogonalized layer of the second pair, a first scaling factor is applied to the first orthogonalized layer and a second scaling factor is applied to the second orthogonalized layer. Applying the first scaling factor and the second scaling factor may include summing a product of the first orthogonalized layer and the first scaling factor, a product of the second orthogonalized layer and the second scaling factor, and the third orthogonalized layer to generate the final image. In this way, the final image may be composed by multiplying the first scaling factor and the first orthogonalized layer to generate a scaled first orthogonalized image, multiplying the second scaling factor and the second orthogonalized layer to generate a scaled second orthogonalized, and adding the scaled first orthogonalized image, the scaled second orthogonalized image, and the third orthogonalized image (e.g., a non-scaled third orthogonalized image) together.

At 316, the method 300 includes displaying a final image with a display device and/or storing the final image in memory. The final image may be displayed using a display device, such as a display device communicatively coupled to a computing system, which may be the computing system 124 of FIG. 1. In this way, a user may visually evaluate the content of the final image. By restoring resolution of image and increasing image quality, the user may identify features of interest within the final image more easily. Further the reconstructed image may be stored in memory of the computing system (e.g., memory 128 of FIG. 1) or in an image archive such as a picture archive and communication system to enable a user to access the final image at a later time. The method 300 then ends.

It may be understood that the method 300 is exemplary and a process for generating the morphology-based composition may differ without departing from the scope of the present disclosure. For example, the additional image processing may be optional depending on an initial image quality of the input image.

FIG. 4A shows an input image 400 wherein a plurality of white top hat (WTH) transforms are applied to the input image. The input image 400 is a 100×100 pixel image simulated with a digital phantom, the digital phantom includes a 2×2 white pixel square, 4×4 pixel square, and 8×8 pixel square. All intensities of the pixels in the square is one, and the background is zero. The input image 400 is computed based on an optical system with a blurring point spread function in a Gaussian distribution with a standard deviation of two pixels. The input image 400 also includes a diffusive background, which is a Gaussian distribution with a standard deviation of 20 pixels and peak intensity of 0.1, is superimposed as the background intensity variation. In addition, an additive Poisson noise was applied.

FIG. 4B is an image 401 of a product of a 2D deconvolution treatment wherein a dark halo surrounds the bright squares. FIG. 4C is a final image 402 generated according to the embodiment described herein, wherein the final image is composed from two or more orthogonalized layers that are scaled using a respective scaling ratio. When compared with input image 400, the square included in final image 402 exhibits higher contrast, increased resolution, and the background intensity is effectively reduced without the presence of a dark halo artifact (as seen in image 401).

FIGS. 4D, 4E, and 4F show a plurality of white top hat transformed images, including first white top hat (WTH) transformed image 403, a second WTH transformed image 404, and a third WTH transformed image 405, generated with a plurality of white top-hat (WTH) transforms. The plurality of WTH transforms may be performed according to the method described above with regards to FIG. 3. Similarly, the WTH transformed images may be used to generate the two or more orthogonalized layers wherein the final image 402 is composed of. The plurality of WTH transforms may include a first WTH transform, a second WTH transform, and a third WTH transform that may be applied to the input image 400 to generate the first WTH transformed image 403 with extracted image components, the second WTH transformed image 404 with extracted image components, and the third WTH transformed image 405 with extracted image components, respectively.

The first WTH transformed image 403 is generated by performing the first WTH transform with a first structure element with a size of 3 pixels on the input image 400, the second WTH transformed image 404 is generated by performing the second WTH transform may be performed with a second structure element with a size of 9 pixels on the input image 400 and a third WTH transformed image 405 may be generated by performing the third WTH transform with a third structure element with a size of 51 pixels on the input image 400. The first structure element, the second structure element, and the third structure element are flat square structure elements. The first structure element is smallest in size, the second structure element is intermediate in size, and the third structure element is largest in size.

The first WTH transformed image 403 includes smaller features compared to the second WTH transformed image 404 and the third WTH transformed image 405. The smallest structure element extracts smaller features of high intensity. In this way, high frequency image components are collected in the first WTH transformed image 403. The second WTH transformed image 404 includes larger features compared to the first WTH transformed image 401 and smaller features compared to the third WTH transformed image 405. Thus, the intermediate structure element extracts larger features of lower intensity than the smallest structure element. The third WTH transformed image 405 includes larger features compared to the first WTH transformed image 403 and the second WTH transformed image 404, and accordingly, the intermediate structure element extracts larger of lower intensity than the smallest structure element and the intermediate structure element.

FIGS. 5A, 5B, and 5C show a plurality of orthogonalized layers generated based on a plurality of white top hat (WTH) transformed images. The plurality of WTH transformed image may be the plurality of WTH transformed images (e.g., the first WTH transformed image 403, the second WTH transformed image 404, and the third WTH transformed image 405) described above with regards to FIGS. 4D-4F. The plurality of orthogonalized layers may include a first orthogonalized layer 500, a second orthogonalized layer 501, and a third orthogonalized layer 503.

The first orthogonalized layer 500 may be a first WTH transformed image with extracted feature components, such as the first WTH transformed image 403 of FIG. 4D. The second orthogonalized layer 501 may be the difference between a second WTH transformed image (e.g., the second WTH transformed image 404 of FIG. 4E) with extracted image components and the first WTH transformed image with extracted image components. The third orthogonalized layer 503 may be the difference between a third WTH transformed image (e.g., the third WTH transformed image 405 of FIG. 4F) with extracted image components and the second WTH transformed image with extracted image components. The first orthogonalized layer 500 represents intensity of the top layer, the second orthogonalized layer 501 represents intensity of the middle layer, and the third orthogonalized layer 503 represents the base components of the original image.

FIG. 5D shows a stacked intensity profile 505 illustrating the contributions of the plurality of orthogonalized layers of a morphology-based composition in the image resolution restoration process. The stacked intensity profile 505 is an intensity profile of a pixels along a horizontal row across the middle of the digital phantom (e.g., the 2×2 pixel square, the 4×4 pixel square, and the 8×8 pixel square described above in FIG. 4A). The stacked intensity profile 505 includes first curve 502, a second curve 504, a third curve 506, a fourth curve 508, a fifth curve 510, and a sixth curve 512.

The first curve 502 (e.g., a connected solid line with large filled circles) represents the intensity of the input image (e.g., input image 400 of FIG. 4A). A first peak 514 at x=20, a second peak 516 at x=30, and a third peak at x=60 of the first curve 502 indicates peak reduction and broadening due to a resolution-degrading PSF of a simulated optical system when compared to an original straight-wall intensity profile with an intensity of one. The second curve 504 represents (e.g., connected solid line with a cross marker) the 2D deconvolution algorithm results after 50 iterations. When compared with the first curve 502, the peak height is increased and peak width is decreased for the first peak 514 and the second peak 516. However, the contrast of the background between the second peak 516 and third peak 518 is reduced (e.g., background intensity between x=35 and x=50 is higher than zero) due to the inability of two-dimensional (2D) deconvolution to remove background intensity variation.

The third curve 506 (e.g., solid line) represents the final image generated according to the embodiments described herein, which is a morphology-based composition based on applying a first scaling factor between the first orthogonalized layer 500 and the second orthogonalized layer 501 and a second scaling factor between the second orthogonalized layer 501 and the third orthogonalized layer 503. When compared with the first curve 502, the peak height is increased and peak width is decreased for the first peak 514 and the second peak 516, similar to the second curve 504. However, when compared with the second curve 504, the contrast between the second peak 516 and the third peak 518 is increased, indicating a reduction in background intensity variation between x=35 and x=50.

The fourth curve 508 (e.g., dashed line) represents the contribution of the third orthogonalized layer 503 to the intensity. The fifth curve 510 (e.g., dash-dot line) represents the contribution of second orthogonalized layer 501 to the intensity. The sixth curve 512 (e.g., dotted line) represents the contribution of the first orthogonalized layer 500 to the intensity. Generally, high frequency noise is collected in the first orthogonalized layer 500. The high frequency noise may be reduced by performing a denoising algorithm, such as a low-pass filtering algorithm or wavelet denoising algorithm.

When compared to the fourth curve 508, the fifth curve 510 and the sixth curve 512 contribute more significantly to resolution restoration. The fourth curve 508 contributes significantly more to background intensity variation than the fifth curve 510 and the sixth curve 512 since the third orthogonalized layer 503 includes the largest image feature components. It may be noted that the background intensity variation may further be reduced when a scaling factor applied to the third orthogonalized layer 503 is reduced to lower than one or even zero.

FIGS. 6A, 6B, 6C, and 6D show an input image 600, a final image 601 based on a morphology-based composition, and a deconvolution algorithm result 603, and a stacked intensity profile 605. The input image 600 is an image simulated with a digital phantom, the digital phantom including an HL60 nucleus. The input image 600 is on a superposition of a first image wherein a blurring point spread function (PSF) in a Gaussian distribution with a standard deviation of two pixels is applied to the ground truth image and a second image wherein a blurring point spread function (PSF) in a Gaussian distribution with a standard deviation of 20 pixels is applied to the ground truth image. The second image with increased intensity attenuation is superimposed onto the first image to simulate out-of-focus contamination and Poisson noise is applied to the simulated image to generate the input image 600.

The final image 601 (e.g., morphological-based composition) may be generated with a plurality of orthogonalized layers, which may include a first orthogonalized layer, a second orthogonalized layer, and a third orthogonalized layer. As described herein, for biological samples, the circular structure elements may be more compatible with features of biological subjects. As such, the first orthogonalized layer may be a first WTH transformed image with extracted feature components generated by performing a first WTH transform on the input image with a structure element size of 5 pixels (e.g., circular structure element with size of 5×5). The second orthogonalized layer may be the difference between a second WTH transformed image with extracted image components and the first WTH transformed image with extracted image components. The second WTH transformed image with extracted image components may be generated by performing a second WTH transform on the input image with a structure element size of 21 pixels (e.g., circular structure element with size of 21×21).

The third orthogonalized layer may be the difference between a third WTH transformed image with extracted image components and the second WTH transformed image with extracted image components. The third WTH transformed image with extracted image components may be generated by performing a third WTH transform on the input image with a structure element size of 81 pixels (e.g., circular structure element with size of 81×81). The first orthogonalized layer may represent intensity of the top layer, the second orthogonalized layer may represent intensity of the middle layer, and the third orthogonalized layer may represent the base layer of the input image. An additional denoising algorithm may be applied to the first orthogonalized layer to reduce the additive Poisson noise introduced when generating the input image. More specifically, equation 2 may be applied to the first orthogonalized layer (or top layer).

The deconvolution algorithm result 603 may be a 2-dimensional (2D) Richardson-Lucy (RL) algorithm after 50 iterations. The 2D RL algorithm may be performed according to the following equation:

$${\hat{I}}_{k + 1} = {\hat{I}}_{k} ( P S F * \frac{I}{P S F ⊗ {\hat{I}}_{k}} ) \qquad ( 5 )$$

where I may be an input image, such as input image 600, PSF is a blurring point spread function, Îₖ₊₁ is a deconvolution result after k iterations, * is a correlation operator, and ⊗ is a convolution operator.

The deconvolution algorithm result 603 shows sharper image feature details and restored intensity. However, the 2D RL algorithm fails to remove the background intensity variation due to the algorithms inability to remove the simulated out-of-focus emission. Further, the deconvolution algorithm result 603 exhibits undesired artifacts, such as poor contrast in addition to a “white halo” due to noise amplification around the bright objects, when compared to the final image 601 (or morphological-based composition). The undesired artifacts in the 2D RL result may not be reduced (e.g., by reducing a number of iterations of the RL algorithm) without affecting a quality of the resolution restoration.

FIG. 6D shows a stacked intensity profile 605 illustrating the contributions of the plurality of orthogonalized layers of a morphology-based composition in the image resolution restoration process. The stacked intensity profile 605 includes first curve 602, a second curve 604, a third curve 606, a fourth curve 608, a fifth curve 610, a sixth curve 612, and a seventh curve 614.

The first curve 602 (e.g., a connected scatter plot with large open dots) represents the intensity of the input image 600. The second curve 604 represents (e.g., a solid line with a cross marker) the deconvolution algorithm results after 50 iterations. The third curve 606 (e.g., solid line) represents the final image 601, which is a morphology-based composition based on applying a first scaling factor between the first orthogonalized layer and the second orthogonalized layer and a second scaling factor between the second orthogonalized layer and the third orthogonalized layer.

The fourth curve 608 (e.g., dashed line) represents the contribution of the third orthogonalized layer to the intensity. The fifth curve 610 (e.g., dash-dot line) represents the contribution of second orthogonalized layer to the intensity. The sixth curve 612 (e.g., dotted line) represents the contribution of the first orthogonalized layer to the intensity. The seventh curve 614 (a solid line with filled circles) represents the intensity of the ground truth image. When compared to the first curve 602 (e.g., the input image 600) and the second curve 604 (e.g., deconvolution algorithm result 603), the third curve 606 includes removed background intensity and a full-width-at-half-maximum (FWHM) are reduced, indicating an increase in resolution in the final image 601.

The technical effect of generating a morphology-based composition based on an input image wherein the morphology-based composition is a final image generated from two or more orthogonalized layers strategically scaled with one or more scaling factors based on two or more structure element sizes and the instrument point spread function and image data is that image quality and image resolution is increased while reducing a time duration of computation and computational complexity when compared to 2D deconvolutions. As such, the process for generating the morphology-based composition may be automated and image processing may not rely on user intervention to generate final images with increased image quality. This can enable faster processing and throughput, as well as more efficient processing.

The disclosure also provides support for a system, comprising: a computing device including a processor configured to execute instructions stored in non-transitory memory that, when executed, cause the processor to: receive an input image and perform a first white top hat (WTH) transform, a second WTH transform, and a third WTH transform on the input image to generate a first WTH transformed image, a second WTH transformed image, and a third WTH transformed image, generate a first orthogonalized layer, a second orthogonalized layer, and a third orthogonalized layer based on the first WTH transformed image, the second WTH transformed image, and the third WTH transformed image, calculate a first scaling factor between the first orthogonalized layer and the second orthogonalized layer and a second scaling factor between the second orthogonalized layer and the third orthogonalized layer, generate a final image by applying the first scaling factor to the first orthogonalized layer and the second scaling factor to the second orthogonalized layer, the final image being a morphology-based composition, and display the final image with a display device and/or storing the final image in memory. In a first example of the system, the input image is a fluorescent microscopy image. In a second example of the system, optionally including the first example, additional image processing is optionally performed on the first orthogonalized layer, the second orthogonalized layer, and the third orthogonalized layer.

The disclosure also provides support for a method, comprising: operating a computing device communicatively coupled to a microscopy system to generate a morphology-based composition based on an input image generated by the computing device based on signals received from a detector of the microscopy system, the morphology-based composition being a final image generated by performing one or more white top hat (WTH) transforms on the input image, generating two or more image layers based on two or more WTH transformed images, and scaling pairs of adjacent image layers based on one or more scaling factors, each scaling factor being based on an estimated point spread function to be reached, two structure element sizes, and image data.

In a first example of the method, the two or more WTH transformed images are generated by performing one or more WTH transforms based on structure elements of two or more sizes, each structure element being a different size and having a pre-determined geometry and pre-determined value. In a second example of the method, optionally including the first example, the two or more image layers comprises two or more orthogonalized layers, each orthogonalized layer being linearly independent. In a third example of the method, optionally including one or both of the first and second examples, each orthogonalized layer comprises one of a WTH transformed image generated with a smallest structure element or an image generated by subtracting one WTH transformed image with a smaller structure element from another WTH transformed image with a larger structure element.

In a fourth example of the method, optionally including one or more or each of the first through third examples, the two or more orthogonalized layers comprises one of a top layer and a base layer or the top layer, one or more intermediate layers, and the base layer. In a fifth example of the method, optionally including one or more or each of the first through fourth examples, the top layer is computed with a smallest structure element and the base layer is computed with a largest structure element. In a sixth example of the method, optionally including one or more or each of the first through fifth examples scaling pairs of adjacent image layers based on one or more scaling factors, each scaling factor being based on the estimated point spread function to be reached, two structure element sizes, and the image data comprises: calculating the one or more scaling factors between a pair of adjacent orthogonalized layers, and applying each scaling factor to a respective orthogonalized layer of the pair of adjacent orthogonalized layers and composing the final image based on one or more scaled orthogonalized layers.

In a seventh example of the method, optionally including one or more or each of the first through sixth examples, the pair of adjacent orthogonalized layers comprise one of the top layer and the base layer, the top layer and one of the one or more intermediate layers, two intermediate layers of the one or more intermediate layers, and one of the one or more intermediate layers and the base layer. In an eighth example of the method, optionally including one or more or each of the first through seventh examples, applying each scaling factor to the respective orthogonalized layer of the pair of adjacent orthogonalized layers and composing the final image based on the scaled orthogonalized layers comprises multiplying one orthogonalized layer of the pair of adjacent orthogonalized layers by a respective scaling factor for each pair of adjacent orthogonalized layers, and adding each scaled orthogonalized layer and non-scaled orthogonalized layer together.

The disclosure also provides support for a method, comprising: receiving an input image and performing a first white top hat (WTH) transform, a second WTH transform, and a third WTH transform on the input image to generate a first WTH transformed image, a second WTH transformed image, and a third WTH transformed image, generating a first orthogonalized layer, a second orthogonalized layer, and a third orthogonalized layer based on the first WTH transformed image, the second WTH transformed image, and the third WTH transformed image, calculating a first scaling factor between the first orthogonalized layer and the second orthogonalized layer and a second scaling factor between the second orthogonalized layer and the third orthogonalized layer, generating a final image by applying the first scaling factor to the first orthogonalized layer and the second scaling factor to the second orthogonalized layer, the final image being a morphology-based composition, and displaying the final image with a display device and/or storing the final image in memory.

In a first example of the method, the first WTH transform is performed with a first structure element of a first size, the second WTH transform is performed with a second structure element of a second size, and the third WTH transform is performed with a third structure element of a third size. In a second example of the method, optionally including the first example, the first structure element is the smallest, the third structure element is the largest, and the second structure element is an intermediate size between the first structure element and the third structure element. In a third example of the method, optionally including one or both of the first and second examples, the first orthogonalized layer is the first WTH transformed image, the second orthogonalized layer is a difference between the second WTH transformed image and the first WTH transformed image, and the third orthogonalized layer is a difference between the third WTH transformed image and the second WTH transformed image.

In a fourth example of the method, optionally including one or more or each of the first through third examples, the first orthogonalized layer is a top layer, the second orthogonalized layer is an intermediate layer, and the third orthogonalized layer is a base layer and additional image processing is optionally performed on the first orthogonalized layer, the second orthogonalized layer, and the third orthogonalized layer. In a fifth example of the method, optionally including one or more or each of the first through fourth examples, the first scaling factor is based on an estimated point spread function to be reached, the first size of the first structure element, the second size of the second structure element, an estimated point spread function of an imaging system, and image data.

In a sixth example of the method, optionally including one or more or each of the first through fifth examples, the second scaling factor is based on the estimated point spread function to be reached, the second size of the second structure element, the third size of the third structure element, and image data. In a seventh example of the method, optionally including one or more or each of the first through sixth examples, applying the first scaling factor and the second scaling factor comprises summing a product of the first orthogonalized layer and the first scaling factor, a product of the second orthogonalized layer and the second scaling factor, and the third orthogonalized layer to generate the final image.

As used herein, an element or step recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. A system, comprising:
a computing device including a processor configured to execute instructions stored in non-transitory memory that, when executed, cause the processor to:
receive an input image and perform a first white top hat (WTH) transform, a second WTH transform, and a third WTH transform on the input image to generate a first WTH transformed image, a second WTH transformed image, and a third WTH transformed image;
generate a first orthogonalized layer, a second orthogonalized layer, and a third orthogonalized layer based on the first WTH transformed image, the second WTH transformed image, and the third WTH transformed image;
calculate a first scaling factor between the first orthogonalized layer and the second orthogonalized layer and a second scaling factor between the second orthogonalized layer and the third orthogonalized layer;
generate a final image by applying the first scaling factor to the first orthogonalized layer and the second scaling factor to the second orthogonalized layer, the final image being a morphology-based composition; and
display the final image with a display device and/or storing the final image in memory.

2. The system of claim 1, wherein the input image is a fluorescent microscopy image.

3. The system of claim 1, wherein additional image processing is optionally performed on the first orthogonalized layer, the second orthogonalized layer, and the third orthogonalized layer.

4. A method, comprising:
operating a computing device communicatively coupled to a microscopy system to generate a morphology-based composition based on an input image generated by the computing device based on signals received from a detector of the microscopy system, the morphology-based composition being a final image generated by performing one or more white top hat (WTH) transforms on the input image, generating two or more image layers based on two or more WTH transformed images, and scaling pairs of adjacent image layers based on one or more scaling factors, each scaling factor being based on an estimated point spread function to be reached, two structure element sizes, and image data.

5. The method of claim 4, wherein the two or more WTH transformed images are generated by performing one or more WTH transforms based on structure elements of two or more sizes, each structure element being a different size and having a pre-determined geometry and pre-determined value.

6. The method of claim 4, wherein the two or more image layers comprises two or more orthogonalized layers, each orthogonalized layer being linearly independent.

7. The method of claim 6, wherein each orthogonalized layer comprises one of a WTH transformed image generated with a smallest structure element or an image generated by subtracting one WTH transformed image with a smaller structure element from another WTH transformed image with a larger structure element.

8. The method of claim 6, wherein the two or more orthogonalized layers comprises one of a top layer and a base layer or the top layer, one or more intermediate layers, and the base layer.

9. The method of claim 8, wherein the top layer is computed with a smallest structure element and the base layer is computed with a largest structure element.

10. The method of claim 4, scaling pairs of adjacent image layers based on one or more scaling factors, each scaling factor being based on the estimated point spread function to be reached, two structure element sizes, and the image data comprises:
calculating the one or more scaling factors between a pair of adjacent orthogonalized layers; and
applying each scaling factor to a respective orthogonalized layer of the pair of adjacent orthogonalized layers and composing the final image based on one or more scaled orthogonalized layers.

11. The method of claim 10, wherein the pair of adjacent orthogonalized layers comprise one of the top layer and the base layer, the top layer and one of the one or more intermediate layers, two intermediate layers of the one or more intermediate layers, and one of the one or more intermediate layers and the base layer.

12. The method of claim 10, wherein applying each scaling factor to the respective orthogonalized layer of the pair of adjacent orthogonalized layers and composing the final image based on the scaled orthogonalized layers comprises multiplying one orthogonalized layer of the pair of adjacent orthogonalized layers by a respective scaling factor for each pair of adjacent orthogonalized layers, and adding each scaled orthogonalized layer and non-scaled orthogonalized layer together.

13. A method, comprising:
receiving an input image and performing a first white top hat (WTH) transform, a second WTH transform, and a third WTH transform on the input image to generate a first WTH transformed image, a second WTH transformed image, and a third WTH transformed image;
generating a first orthogonalized layer, a second orthogonalized layer, and a third orthogonalized layer based on the first WTH transformed image, the second WTH transformed image, and the third WTH transformed image;
calculating a first scaling factor between the first orthogonalized layer and the second orthogonalized layer and a second scaling factor between the second orthogonalized layer and the third orthogonalized layer;
generating a final image by applying the first scaling factor to the first orthogonalized layer and the second scaling factor to the second orthogonalized layer, the final image being a morphology-based composition; and
displaying the final image with a display device and/or storing the final image in memory.

14. The method of claim 13, wherein the first WTH transform is performed with a first structure element of a first size, the second WTH transform is performed with a second structure element of a second size, and the third WTH transform is performed with a third structure element of a third size.

15. The method of claim 14, wherein the first structure element is the smallest, the third structure element is the largest, and the second structure element is an intermediate size between the first structure element and the third structure element.

16. The method of claim 13, wherein the first orthogonalized layer is the first WTH transformed image, the second orthogonalized layer is a difference between the second WTH transformed image and the first WTH transformed image, and the third orthogonalized layer is a difference between the third WTH transformed image and the second WTH transformed image.

17. The method of claim 13, wherein the first orthogonalized layer is a top layer, the second orthogonalized layer is an intermediate layer, and the third orthogonalized layer is a base layer and additional image processing is optionally performed on the first orthogonalized layer, the second orthogonalized layer, and the third orthogonalized layer.

18. The method of claim 13, wherein the first scaling factor is based on an estimated point spread function to be reached, the first size of the first structure element, the second size of the second structure element, an estimated point spread function of an imaging system, and image data.

19. The method of claim 13, wherein the second scaling factor is based on the estimated point spread function to be reached, the second size of the second structure element, the third size of the third structure element, and image data.

20. The method of claim 13, wherein applying the first scaling factor and the second scaling factor comprises summing a product of the first orthogonalized layer and the first scaling factor, a product of the second orthogonalized layer and the second scaling factor, and the third orthogonalized layer to generate the final image.
